(19) United States
(12) Patent Application Publication
(10) Pub. No.: US 2006/0134341 A1
(43) Pub. Date: Jun. 22, 2006

(54) Protection of construction materials from pests

(76) Inventors: David Glassel, Spring, TX (US); Gary Ernest Mellema, Grapevine, TX (US)

Correspondence Address: Martin L. McGregor, 26415 Oak Ridge Drive, Spring, TX, 77380, US

(21) Appl. No.: 11/016,600

(22) Filed: Dec. 17, 2004

(51) Int. Cl. B05D 1/18

(52) U.S. Cl. 427/440

(57) ABSTRACT

A method preventing biological damage to construction materials by treatment with a composition comprising a silicone polymer, a hydrocarbon solvent and optionally an essential oil is provided. A protective effect by reducing the moisture absorption of cellulose materials to below 20% by contacting the material with a silicone polymer to reduce the hygroscopic nature of the wood is also provided.

### TECHNICAL FIELD

This invention provides methods and compositions of matter for protecting construction materials from biological attack. The methods and compositions of the invention are especially useful in protecting construction materials, from attack by insects such as termites.

### BACKGROUND OF THE INVENTION

Preservation of construction materials by treatment with various agents has been practiced for many years. Among the earliest treatments was the application of tars or creosotes to wood such as railway ties that would be in contact with the earth. Various harmful biological agents are known that are capable of attacking wood, causing significant damage. Among these biological agents harmful to wood are insects, for example beetles (a term which includes various species of wood-eating insects whose larvae gnaw and bore wood), termites, moths, etc., and fungi, for example Poria vaillantii Fr., Coniophora cerebella Duey, Merulius lacrymans Wulf, Lentinus lepideus Fr., Lenzites sepiaria Wulf, Chaetomium globosum Kunz, etc. Many of these species are known to favor wet or water soaked wood. The products normally used for treating and conserving wood generally comprise one or more active substances that are effective against the harmful biological agents to be eliminated, for example one or more insecticides and/or fungicides, and a vehicle for introducing the active substances into the tunnels and cavities generated in the wood by the action of the harmful biological agents. The number of vehicles that are effective as active substance carriers inside the wood is currently very limited. Among those materials normally used in products for treating and conserving wood are water, inorganic arsenic derivatives, pentachlorophenol and creosote. Water is the most commonly used carrier for wood preservatives. However, it scarcely penetrates the wood after application and allows diffusion of materials from the treated wood into the environment. Furthermore the active substances applied to the wood using water as the vehicle often do not satisfactorily penetrate it, remaining on the surface, thereby significantly reducing the effectiveness of the active substances. Ramos, U.S. Pat. No. 6,673,836 states that “other vehicles have a very slight wood penetration index, generally about 2 to 6 mm after 24 hours. In soft and porous woods, penetration indices of the vehicle of up to 6 mm are obtained, whereas in hard and non-porous woods, the vehicles penetrate between 2 and 3 mm during a 24 hour time period.” Ramos disclosed many combinations that were considered of little use and claimed a mixture of toluene (40-70%), xylene (6-40%), benzophenone (3-18%), butyl glycol (2-9%), cetyl acetate (1-7%) and methanol (0.3-4%), as a carrier for insecticides into wood. Ramos clearly teaches away from the non-aromatic materials used in the present invention. In contrast to Ramos results, the present invention completely penetrates the wood. Tests have been conducted up to the size of railway crossties with complete penetration from one hour of immersion.

A method of and a composition for treating wood with an insecticide is disclosed in Qader, U.S. Pat. No. 6,638,574. The composition comprises an insecticide such as a pyrethroid dissolved in a supercritical fluid such as carbon dioxide. The composition may also include a co-solvent such as methanol. The method includes impregnating wood with the composition and reducing the temperature and pressure below critical levels to precipitate the insecticide within the wood. In contrast to Qader's approach that requires use of pressure vessels to maintain supercritical solvent conditions, the methods of the present invention can be practiced at ambient temperature and pressure. Again the resistance to penetration noted by Qader is surprisingly overcome by the compositions of the present invention. A secret formula wood preservative mixture claiming insect protection was widely marketed in the United States under the trade names Seasonal and Vaccinol from the 1920's to the late 1950s. Whatever this unknown material contained it is certain that it did not contain the silicone polymers of the present invention which were not discovered until decades later.

### SUMMARY OF THE INVENTION

The invention provides a composition of matter useful for preventing damage to cellulose fiber containing construction materials by biological agents that comprises from 65 to 99% of a high-purity, low-odor aliphatic solvent composed primarily of C₇-C₁₆ straight chained paraffinic, cycloparaffinic and isoparaffinic hydrocarbons, that contains less than 0.5% aromatics, a biologically effective amount of an oil selected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, tunneric oil, oil of wintergreen, juniper oil, tall oil, pine oil, and at least 5% of a silicone based polymer that comprises a mixture of (A) a base copolymer of silicone units having the general formula: (MₐD_{b}T_{c}Q_{d})ₓ where M is R₃SiO_{1/2}—; D is R₂SiO—; T is RSiO_{3/2}—; Q is Si(O_{1/2})₄—, R is a generalized organic radical selected from: linear or branched hydrocarbon radicals of 1-8 carbons containing 0-1 degree of unsaturation, or phenyl, or trifluoropropyl radicals; a, b, c, d are real numbers and further provided the ratio of a/(c+d) is between 0 and 4; the ratio of b to the rest is not subject to limitation provided the final base viscosity is between 50-3500 cSt; and at least one R group of each molecule must be a hydrolysable group; (B) a crosslinker having a general (MₐD_{b}T_{c}Q_{d})ₓ formula the following parameters apply: the ratio of a/(c+d) is between 0 and 4; the ratio of b to the rest is not subject to limitation provided the final crosslinker viscosity is below 350 cSt; and R is a generalized organic radical selected from: linear or branched hydrocarbon radicals of 1-8 carbons containing 0-1 degree of unsaturation, or phenyl, or trifluoropropyl radicals and at least one R group of each molecule must be a hydrolysable and a crosslinking catalyst wherein the base copolymer is 75 to 90% by weight and the crosslinker is 9 to 24% by weight and the catalyst is 1 to 5% by weight of the component. Preferably, the aliphatic solvent is composed primarily of C₉-C₁₄ cycloparaffinic and isoparaffinic hydrocarbons more preferably the aliphatic solvent is composed primarily of C₁₀-C₁₃ cycloparaffinic and isoparaffinic hydrocarbons. The best aliphatic solvent known to the inventors is composed primarily of a Conosol solvent designated as Conosol 145 by its manufacturer Penreco, Inc. The composition preferably includes an essential oil and preferred oils are selected from the group consisting of cedar oil, cinnamon oil, citronella oil, clove oil, eucalyptus oil, juniper oil, tall oil, and pine oil especially preferred is cedar oil, also known as cedar wood oil.

The preferred method of treatment useful for improving the properties of wood for use as a construction material that comprises contacting wood with a mixture of the following components: (1) at least 70% by weight of an aliphatic solvent composed primarily of C₇-C₁₆ straight chain aliphatic, cycloparaffinic and isoparaffinic hydrocarbons, that contains less than 0.5% aromatics; (2) 1 to 5% by weight of a natural product oil selected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen, juniper oil, tall oil, pine oil; a synthetic natural product oil mimic that comprises at least one synthetically produced or isolated chemical identified as a component of a natural product oil elected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen, juniper oil, tall oil, pine oil and (3) at least 10% of a silicone based polymer that comprises a mixture of (A) a base copolymer of silicone units having the general formula: (MₐD_{b}T_{c}Q_{d})ₓ where M is R₃SiO_{1/2}—; D is R₂SiO—; T is RSiO_{3/2}—; Q is Si(O_{1/2})₄—; R is a generalized organic radical selected from: linear or branched hydrocarbon radicals of 1-8 carbons containing 0-1 degree of unsaturation, or phenyl, or trifluoropropyl radicals; a, b, c, d are real numbers and further provided the ratio of a/(c+d) is between 0 and 4; the ratio of b to the rest is not subject to limitation provided the final base viscosity is between 50-3500 cSt; and at least one R group of each molecule must be a hydrolysable group; (B) a crosslinker having a general (MₐD_{b}T_{c}Q_{d})ₓ formula the following parameters apply: the ratio of a/(c+d) is between 0 and 4; the ratio of b to the rest is not subject to limitation provided the final crosslinker viscosity is below 350 cSt; and R is a generalized organic radical selected from: linear or branched hydrocarbon radicals of 1-8 carbons containing 0-1 degree of unsaturation, or phenyl, or trifluoropropyl radicals and at least one R group of each molecule must be a hydrolysable and a crosslinking catalyst wherein the base copolymer is 75 to 90% by weight and the crosslinker is 9 to 24% by weight and the catalyst is 1 to 5% by weight of the component. Preferred natural oils include cedar oil, cinnamon oil, citronella oil, clove oil, eucalyptus oil, juniper oil, tall oil, and pine oil, cedar oil (also known as cedar wood oil) is especially preferred.

The invention may also be considered as the composition useful in the In practicing the method of the invention that comprises a mixture of the following components: (1) at least enough aliphatic hydrocarbon solvent composed primarily of C₇-C₁₆ straight chain aliphatic, cycloparaffinic and isoparaffinic hydrocarbons, that contains less than 0.5% aromatics; (2) a biologically effective amount not to exceed about 5% of a natural product oil selected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen, juniper oil, tall oil, pine oil; a synthetic natural product oil mimic that comprises at least one synthetically produced or isolated chemical identified as a component of a natural product oil elected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen, juniper oil, tall oil, pine oil and (3) a silicone based polymer that comprises a mixture of (A) a base copolymer of silicone units having the general formula: (MₐD_{b}T_{c}Q_{d})ₓ where M is R₃SiO_{1/2}—; D is R₂SiO—; T is RSiO_{3/2}—; Q is Si(O_{1/2})₄—; R is a generalized organic radical selected from: linear or branched hydrocarbon radicals of 1-8 carbons containing 0-1 degree of unsaturation, or phenyl, or trifluoropropyl radicals; a, b, c, d are real numbers and further provided the ratio of a/(c+d) is between 0 and 4; the ratio of b to the rest is not subject to limitation provided the final base viscosity is between 50-3500 cSt; and at least one R group of each molecule must be a hydrolysable group; (B) a crosslinker having a general (MₐD_{b}T_{c}Q_{d})ₓ formula the following parameters apply: the ratio of a/(c+d) is between 0 and 4; the ratio of b to the rest is not subject to limitation provided the final crosslinker viscosity is below 350 cSt; and R is a generalized organic radical selected from: linear or branched hydrocarbon radicals of 1-8 carbons containing 0-1 degree of unsaturation, or phenyl, or trifluoropropyl radicals and at least one R group of each molecule must be a hydrolysable and a crosslinking catalyst. Preferred compositions are those wherein the base copolymer is 75 to 90% by weight and the crosslinker is 9 to 24% by weight and the catalyst is 1 to 5% by weight of the component and the overall mixture is from 65 to 95% by weight aliphatic solvent, a biologically effective amount of a natural product oil, preferably from 1 to 5% by weight oil and the silicone based polymer is at least 5% by weight. The composition also comprises a crosslinking catalyst that promotes film formation in the silicone-based component. While any catalyst maybe used preferred catalysts are metal soaps, especially preferred are catalysts selected from the group consisting of metal salts of alkylcarboxylic acids having from 2 to 18 carbons, and more especially preferred metal soaps are tetraalkyl titanates or zirconates.

Protection of wood and other cellulose based materials against fungi and insects can also be achieved by exclusion of absorbed water from wood fiber or cellulose materials by contacting the surface to be protected with a reactive silicone polymer having the following characteristics: a base copolymer of silicone units having the general formula: (MₐD_{b}T_{c}Q_{d})ₓ where M is R₃SiO_{1/2}—; D is R₂SiO—; T is RSiO_{3/2}—; Q is Si(O_{1/2})₄—; R is a generalized organic radical selected from: linear or branched hydrocarbon radicals of 1-8 carbons containing 0-1 degree of unsaturation, or phenyl, or trifluoropropyl radicals; a, b, c, d are real numbers and further provided the ratio of a/(c+d) is between 0 and 4; the ratio of b to the rest is not subject to limitation provided the final base viscosity is between 50-3500 cSt; and at least one R group of each molecule must be a hydrolysable group. Preferred polymers are those having R¹ groups that are methyl and R² groups that are not methyl, where 70 to 99% of the groups are R¹ and 1% to 10% of R² groups have a hydroxyl, alkoxy, or acyl group. The natural viscosity of the silicone polymer limits its entry into a cellulose fiber or wood vascular system. While surface treatment is possible with the undiluted polymer, penetration of a material requires thinning of the polymer. Therefore it is helpful to dilute the silicone polymer with a diluent to lower its viscosity and enhance vascular mobility of the polymer. A suitable diluent will not be damaging to the environment or to humans or pets exposed to the treated wood. White mineral oils, particularly an aliphatic solvent composed primarily of C₇-C₁₆ straight chain aliphatic, cycloparaffinic and isoparaffinic hydrocarbons, that contains less than 0.5% aromatics is an effective diluent for silicone polymers. Especially preferred are an aliphatic solvent composed primarily of C₉ to C₁₄, more preferably C₁₀-C₁₃ straight chain paraffinic, cycloparaffinic and isoparaffinic hydrocarbons, that contains less than 0.5% aromatics, such as Conosol 145 marketed by Penreco, Inc. of Houston Tex. A suitable composition will have at least 5% silicone polymer and the balance will be a diluent.

### DETAILED DESCRIPTION OF THE INVENTION

### General Description of the Invention

In order to understand the invention at its most basic level it is importation to understand the basic properties of wood. According to a standard text, “Construction: Principles, Materials, and Methods” by Simmons, H. Leslie.; Olin, Harold Bennett, New York, N.Y., John Wiley & Sons, Inc. (US), 2001, Chapter 6 page 366 et seq., {Cited below as Simmons et al.} (Captions deleted from quotation. “ . . . ” indicates deletions other than captions and [ ] indicates insertions or change in case), “ . . . [w]ood cells, or fibers, are primarily cellulose cemented together with lignin. The wood structure is about 70% cellulose, between 12% and 28% lignin, and up to 1% ash-forming materials. These constituents give wood its hygroscopic properties, its susceptibility to decay, and its strength. The bond between individual fibers is so strong that when tested in tension they commonly tear apart rather than separate. The rest of wood, although not part of its structure, consists of extractives that give different species distinctive characteristics such as color, odor, and natural resistance to decay.

It is possible to dissolve the lignin in wood chips using chemicals, thus freeing the cellulose fibers. By further processing, these fibers can then be turned into a pulp from which paper and paperboard products are made. It is also possible to chemically convert cellulose so that it may be used to make textiles (such as rayon), plastics, and other products that depend on cellulose derivatives.

Wood is hygroscopic, meaning that it expands when it absorbs moisture and shrinks when it dries or loses moisture. This property affects the end use of wood. Although the wet (green) condition is normal for wood throughout its life as a tree, most products made of wood require that it be used in a dry condition; therefore, seasoning by drying to an acceptable moisture content is necessary.

The moisture content of wood is the weight of water it contains, expressed as a percentage of the weight of the wood when oven dry. The weight of the water in wet wood can be twice that in wood that is oven dry . . . .

In living trees the amount of moisture varies widely between different species, among individual trees of the same species, among different parts of a tree, and between sapwood and heartwood. Many softwoods have a large proportion of moisture in the sapwood and far less in the heartwood, while most hardwoods have about the same moisture content in both sapwood and heartwood. The extreme limits of moisture content in green softwoods can be shown by comparing the moisture content of the heartwood of Douglas fir and southern pine, which may be as low as 30%, to the moisture content of the sapwood of cedars and redwoods, which may be as high as 200%.

Moisture in green wood is present in two forms: in the cell cavities as free water and within the cell fibers as absorbed water. When wood dries, its cell fibers give off their absorbed water only after all the free water is gone and the adjacent cell cavities are empty. The point at which the fibers are still fully saturated, but the cell cavities are empty, is called the fiber saturation point. In most species this occurs at about 30% moisture content. The significance of this condition is that it represents the point at which shrinkage begins. Even lumber cut with a green moisture content as high as 200% [of dry weight] can dry to the fiber saturation point (30% moisture content) with no shrinkage of the wood. Only when the cell fibers begin to give off their absorbed water and start to constrict does the wood shrink.”

The moisture content of wood is a significant factor in determining whether the wood will be subject to insect or biological attack. Simmons et al, at p 376, summarizes the relationship between moisture and biological damage as follows:

“Fungi (microscopic plants) cause decay, molds, and stains. Fungus growth can develop in wood only under the following conditions:
1. There must be an adequate supply of organic material, which for some fungi is the wood itself.
2. Temperatures must range from 41° F. (5° C.) to 104° F. (40° C.).
3. There must be sufficient oxygen, which is always present unless the wood is completely below the groundwater line or completely submerged in water.
4. The wood's moisture content must exceed 20%.
   . . . The term day rot is an often-used misnomer, because the fungi that cause decay must have access to water in order to function. Decay will not occur in wood that is maintained below a 20% moisture content, which is typical of air-dried wood. Therefore, even wood that is dry when decay is detected must have been wet earlier. Most decay in wood occurs when its moisture content is above the fiber saturation point (30% moisture content). But wood that is continuously water soaked will not decay either, because insufficient oxygen will be present. . . . Many precautions taken to prevent decay are also effective against various insects that attack and destroy wood. Subterranean termites account for about 95% of all termite damage in the United States and a significant portion of the total insect damage. Non-subterranean termites (called dry-wood termites) occur only in the southern part of the country and the lower east and west coastal areas, but they are a hazard where they do exist.”

The protective effects of the invention arise from carrying the biologically active agent into the micro-pores of the wood with a reactive silicone polymer that improves retention of the oil by the wood fibers and lignins within the micropores. The stabilization of the wood's moisture content at less than 20% and reduction in the ability of the wood fibers to absorb water is in itself an important protective effect against biological attack. The silicone polymer and biologically active materials are carried into the wood by the natural vascular system of the wood. As the carrier penetrates into the vascular system, the silicone polymer alters the wood surfaces it contacts to render the wood less hydrophilic and to facilitate movement of the protecting oil deeper into the wood and its retention within the wood.

### EXAMPLE 1

### Preparation of Compositions of the Invention

The compositions of the invention comprises a silicone polymer that is a mixture of alkylsiloxanes having a general base formula of: (MₐD_{b}T_{c}Q_{d})ₓ Where M is R₃SiO_{1/2}—; D is R₂SiO—; T is RSiO_{3/2}—; and Q is Si(O_{1/2})₄— and R is a generalized organic radical selected from: linear or branched hydrocarbon radicals of 1-8 carbons containing 0-1 degree of unsaturation, or phenyl, or trifluoropropyl radicals, and may optionally be substituted with a hydroxyl, alkoxy or acyloxy group of 1 to 8 carbons. A preferred embodiment is: ^{HO}MD_{X}M^{OH} namely a silanol endblocked polydimethylsiloxane. The preferred viscosity is 50-3500 cSt with 750-1500 cSt being especially preferred. The composition is subject to the following general parameters: The ratio of a/(c+d) is between 0 and 4 with the preferred range being 0-0.5. The ratio of b to the rest is not subject to limitation provided the final base viscosity is between 50-3500 cSt with 750-1500 being preferred. R at each position may be the same or different and will be predominately methyl. All R groups being methyl is a preferred choice. In addition, at least one R group of each molecule must include a hydrolysable group such as hydroxy, alkoxy or acyloxy with hydroxy being preferred. The silicone polymer may include a further component capable of crosslinking of the general formula (MₐD_{b}T_{c}Q_{d})ₓ where M, D, T and Q are as defined above and meeting the following parameters: the ratio of a/(c+d) is between 0 and 4; the ratio of b to the rest is not subject to limitation provided the final crosslinker viscosity is below 350 cSt; and R is a generalized organic radical selected from: linear or branched hydrocarbon radicals of 1-8 carbons containing 0-1 degree of unsaturation, or phenyl, or trifluoropropyl radicals and at least one R group of each molecule must be a hydrolysable group. The silicone polymer may also comprise mixtures of the polymer and the crosslinker, and may further comprise a catalyst. Preferred silicone polymers form films in the presence of moisture. Any catalyst that promotes crosslinking may be used. Preferred catalysts are metal soaps, especially preferred are tetraalkyl titanate and tetraalkyl zirconates.

The preferred silicone polymers comprise from 75 to 90% of base polymer more preferably 80 to 85%, most preferable about 82.6% and from 10 to 25% crosslinker more preferably 10 to 17%, most preferably 15% and from 1 to 5% of a catalyst preferably 2 to 3% and most preferably 2.4%. The presently preferred silicone polymer is available from GT Products, Grapevine Tex. as X5814.

The silicone is diluted with an aliphatic solvent composed primarily of C₇-C₁₆ straight chain aliphatic, cycloparaffinic and isoparaffinic hydrocarbons, that contains less than 0.5% aromatics. Preferably the aliphatic solvent is selected is composed primarily of C₉-C₁₄ cycloparaffinic and isoparaffinic hydrocarbons, more preferably primarily of C₁₀-C₁₃ cycloparaffinic and isoparaffinic hydrocarbons, another preferred the aliphatic solvent is composed primarily of solvents capable of meeting applicable standards for a “food grade” classification. The currently most preferred solvent is Conosol 145 marketed by Penreco, Inc. of Houston, Tex. Other suitable solvents are available from Shell Oil Company under the name Shellsol.

Optionally a natural product oil may also be combined with the silicone polymer. The oil may be selected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen, juniper oil, tall oil, pine oil; a synthetic natural product oil mimic that comprises at least one synthetically produced or isolated chemical identified as a component of a natural product oil elected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen, juniper oil, tall oil, pine oil. Preferred oils are cedar oil, cinnamon oil, citronella oil, clove oil, eucalyptus oil, juniper oil, tall oil, and pine oil. Cedar oil (also known as cedarwood oil) is especially preferred.

The over all composition requires a silicone polymer as described above with sufficient aliphatic solvent to carry the silicone polymer into the micro-pore structure of the wood. The overall composition is from 65 to 95% by weight aliphatic solvent, and the silicone based polymer is at least 5% by weight. The composition includes up to 5% by weight natural product oil in at least a biologically effective amount. The composition is prepared as follows: In a power stirred vessel is placed a volume of aliphatic solvent and the silicone based polymer is slowly added with stirring. When the desired volume of silicone based polymer is added, the desired volume of essential oil is slowly added to make up the final mixture. In this manner compositions of 5% Cedar oil in 65% Conosol 145/30% GT 5814; 75% Conosol 145/20% GT 5814; 80% Conosol 145/15% GT 5814 and 85% Conosol 145/ and 10% GT 5814 are prepared. Samples of commercially available Oak, Maple, Yellow pine, and Western pine are treated by immersion in each mixture. Compositions containing a biologically effective amount of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen, juniper oil, tall oil, pine oil are prepared in a similar manner as that described above for cedar oil. A biologically effective amount means the minimum concentration necessary to obtain an observable decrease in biological damage between a treated sample and an untreated control sample of the same materials.

The invention is highly effective in treating wooded construction materials, and may also be beneficially used with materials containing wood fibers or any other cellulose of lignin containing construction material that requires protection against biological attack. The exact selection of treatment compositions and materials will vary depending on the specific protection needed and the availability of treatment materials near the source of the construction materials.

### EXAMPLE 2

### Protection Against Termites

Filter paper comprising pine fibers was immersed in a composition prepared as set out in example 1 and comprising 80% Conosol 145, 15% GT 5814 and 5% Cedar oil and allowed to dry. An untreated control was also provided. The filter papers were placed in a test chamber and 50 worker Formosan Termites were placed in the chamber. After 24 hours the control paper has been almost totally consumed while the treated paper is untouched.

### Insecticidal Activity

Approximately 10 species of insects native to south Texas including German cockroach, cat fleas, mosquitoes, gypsy moths Japanese beetles, homed beetles, were placed in a glass aquarium and exposed to a cube of wood approximately 2 cm on each side that was treated with a composition prepared as set out in example 1 and comprising 80% Conosol 145, 15% X5814 and 5% Cedar oil by immersion for one hour then air drying for 24 hours. After 24 hours, in each case the insects in the treated chamber were dead

### Antifungal Activity

Side by side samples of flooring one piece treated by immersion in a composition prepared as set out in example 1 and comprising 80% Conosol 145, 15% GT 5814 and 5% Cedar oil with air drying and an untreated control from the same lot where placed in a damp area with active mildew growth. After 12 days the surface of the control untreated flooring was almost entirely covered with mildew and the treated flooring remained free of mildew.

We claim:

1. A method of treatment useful for preventing damage to construction materials by biological agents that comprises contacting the material with a composition comprising (1) from 65 to 95% of an aliphatic solvent composed primarily of C₇-C₁₆ straight chain aliphatic, cycloparaffinic and isoparaffinic hydrocarbons, that contains less than 0.5% aromatics; (2) a protective amount of at least one natural product oil selected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen, juniper oil, tall oil, pine oil; a synthetic natural product oil mimic that comprises at least one synthetically produced or isolated chemical identified as a component of a natural product oil elected from the group consisting of almond bitter oil, anise oil, basil oil, bay oil, caraway oil, cardamom oil, cedar oil, celery oil, chamomile oil, cinnamon oil, citronella oil, clove oil, coriander oil, cumin oil, dill oil, eucalyptus oil, fennel oil, ginger oil, grapefruit oil, lemon oil, lime oil, mint oil, parsley oil, peppermint oil, pepper oil, rose oil, spearmint oil (menthol), sweet orange oil, thyme oil, turmeric oil, oil of wintergreen, juniper oil, tall oil, pine oil and the balance further comprising at least one (3) silicone based polymer that forms a film in the presence of a catalyst and water comprising at least one component selected from the group consisting of (A) a copolymer of silicone units having the general formula: (MₐD_{b}T_{c}Q_{d})ₓ where M is R₃SiO_{1/2}—; D is R₂SiO—; T is RSiO_{3/2}—; Q is Si(O_{1/2})₄—; R is a generalized organic radical selected from: linear or branched hydrocarbon radicals of 1-8 carbons containing 0-1 degree of unsaturation, or phenyl, or trifluoropropyl radicals; a, b, c, d are real numbers and further provided the ratio of a/(c+d) is between 0 and 4; the ratio of b to the rest is not subject to limitation provided the final base viscosity is between 50-3500 cSt; and at least one R group of each molecule must be a hydrolysable group; and (B) (MₐD_{b}T_{C}Q_{d})ₓ formula the following parameters apply: the ratio of a/(c+d) is between 0 and 4; the ratio of b to the rest is not subject to limitation provided the final crosslinker viscosity is below 350 cSt; and R is a generalized organic radical selected from: linear or branched hydrocarbon radicals of 1-8 carbons containing 0-1 degree of unsaturation, or phenyl, or trifluoropropyl radicals and at least one R group of each molecule must be a hydrolysable and (C) a catalyst; and maintaining the contact for a time sufficient to establish a change in the wood that provides a decrease in the hydrophilic quality of the pore structure of the wood relative to untreated wood from the same species.

2. The method of claim 1 comprising the aliphatic solvent (1) and the solvent selected is composed primarily of C₉-C₁₄ cycloparaffinic and isoparaffinic hydrocarbons.

3. The method of claim 1 comprising the aliphatic solvent (1) and the solvent selected is composed primarily of C₁₀-C₁₃ cycloparaffinic and isoparaffinic hydrocarbons.

4. The method of claim 1 comprising the aliphatic solvent (1) and the solvent selected is composed primarily of solvents capable of meeting applicable standards for a “food grade” classification.

5. The method of claim 1 comprising the aliphatic solvent (1) and the solvent selected is composed primarily of Conosol 145.

6. The method of claim 1 wherein an oil (2) is selected and further the oil is from the group consisting of cedar oil, cinnamon oil, citronella oil, clove oil, eucalyptus oil, juniper oil, tall oil, and pine oil.

7. The method of claim 1 wherein an oil (2) is selected and further the oil is cedar oil.

8. The method of claim 1 wherein R groups may be the same or different and each is a lower alkyl group of no more that four carbons.

9. The method of claim 1 that comprises a where all copolymer R groups are methyl.

10. The method of claim 1 that comprises a crosslinker having wherein an R group in an alkoxy group is an alkyl group each comprising from 1 to 4 carbon atoms.

11. The method of claim 10 that further comprises methyl groups at non-alkoxy position.

12. A method for preventing fungal or insect damage to cellulose fibers that comprises contacting the cellulose fibers with a composition that comprises a moisture reducing concentration of a silicone polymer comprising silicone units having the general formula: (MₐD_{b}T_{c}Q_{d})ₓ where M is R₃SiO/_{1/2}—; D is R₂SiO—; T is RSiO_{3/2}—; Q is Si(O_{1/2})₄—; R is a generalized organic radical selected from: linear or branched hydrocarbon radicals of 1-8 carbons containing 0-1 degree of unsaturation, or phenyl, or trifluoropropyl radicals; a, b, c, d are real numbers and further provided the ratio of a/(c+d) is between 0 and 4; the ratio of b to the rest is not subject to limitation provided the final base viscosity is between 50-3500 cSt; and at least one R group of each molecule must be a hydrolysable group for a time sufficient to alter the surface activity of the cellulose fibers and thereby reduce the absorption of water from the environment of the cellulose fibers so that the moisture of the cellulose fibers is less than twenty percent of the dry weight of the cellulose fibers when the cellulose fibers are exposed to 100% relative humidity.

13. The method of claim 12 wherein the silicone polymer is diluted with an aliphatic solvent composed primarily of C₇-C₁₆ straight chained paraffinic, cycloparaffinic and isoparaffinic hydrocarbons, that contains less than 0.5% aromatics.

14. The method of claim 12 wherein the silicone polymer is diluted with a white mineral oil.

15. The method of claim 12 wherein the silicone polymer is diluted with an aliphatic solvent composed primarily of C₉-C₁₄ straight chained paraffinic, cycloparaffinic and isoparaffinic hydrocarbons, that contains less than 0.5% aromatics.

16. The method of claim 12 wherein the silicone polymer is diluted with an aliphatic solvent composed primarily of C₁₀-C₁₃ straight chained paraffinic, cycloparaffinic and isoparaffinic hydrocarbons, that contains less than 0.5% aromatics.

17. The method of claim 12 wherein the silicone polymers are have R¹ groups that are methyl and R² groups that are not methyl, where 70 to 99% of the groups are R¹ and 1% to 10% of R² groups have a hydroxyl, alkoxy, or acyl group.

18. A composition of matter that comprises a silicone polymer comprising silicone units having the general formula: (MₐD_{b}T_{c}Q_{d})ₓ where M is R₃SiO_{1/2}—; D is R₂SiO—; T is RSiO_{3/2}—; Q is Si(O_{1/2})₄—; R is a generalized organic radical selected from: linear or branched hydrocarbon radicals of 1-8 carbons containing 0-1 degree of unsaturation, or phenyl, or trifluoropropyl radicals; a, b, c, d are real numbers and further provided the ratio of a/(c+d) is between 0 and 4; the ratio of b to the rest is not subject to limitation provided the final base viscosity is between 50-3500 cSt; and at least one R group of each molecule must be a hydrolysable group and from 65 to 99% of a diluent composed primarily of C₇-C₁₆ straight chained paraffinic, cycloparaffinic and isoparaffinic hydrocarbons, that contains less than 0.5% aromatics.

19. The composition of claim 18 wherein the silicone polymer is diluted with an aliphatic solvent composed primarily of C₉-C₁₄ straight chained paraffinic, cycloparaffinic and isoparaffinic hydrocarbons, that contains less than 0.5% aromatics.

20. The composition of claim 18 wherein the silicone polymer is diluted with an aliphatic solvent composed primarily of C₁₀-C₁₃ straight chained paraffinic, cycloparaffinic and isoparaffinic hydrocarbons, that contains less than 0.5% aromatics.

21. An article of manufacture treated according to claim 1.

22. An article according to claim 21 that comprises wood.

23. An article according to claim 21 that comprises dimensioned lumber.

24. An article according to claim 21 that comprises new growth wood.
